(19) United States
(12) Patent Application Publication
(10) Pub. No.: US 2004/0249963 A1
(43) Pub. Date: Dec. 9, 2004

(54) Network gateway device and communications system for real item communication connections

(76) Inventors: Karl Klaghofer, Munchen (DE); Harald Muller, Gilching (DE); Heribert Muller, Eggenburg (AT); Jurgen Totzke, Poing (DE)

Correspondence Address: Siemens Corporation, Intellectual Property Department, 170 Wood Avenue South, Iselin, NJ, 08830, US

(21) Appl. No.: 10/490,526

(22) PCT Filed: Sep. 9, 2002
(86) PCT No.: PCT/DE02/03345

(51) Int. Cl. G06F 15/16

(52) U.S. Cl. 709/230

(57) ABSTRACT

The invention relates to a network gateway device, which permits a logically direct, transport protocal-based coupling of several VoIP communications networks with different, connection control protocols that are attached to the packet-oriented transport protocol. To achieve this, for each of the VoIP communications networks to be coupled, the network gateway has a respective transport protocol-based data interface, a connection control protocol-based signaling interface, in addition to a conversion device for conversion between the different connection control protocols.

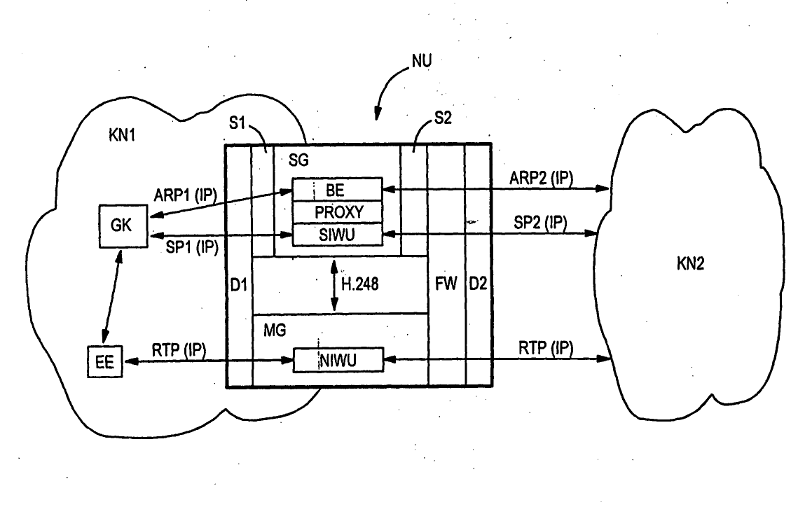

### CROSS REFERENCE TO RELATED APPLICATIONS

This application is the US National Stage of International Application No. PCT/DE02/03345, filed Sep. 9, 2002 and claims the benefit thereof. The International Application claims the benefits of German application No. 10147148.3 DE filed Sep. 25, 2001, both of the applications are incorporated by reference herein in their entirety.

### FIELD OF INVENTION

In modern communication systems, real time connections e.g. for voice, video or multimedia communication are also being routed to an increasing extent via packet oriented communication networks such as LANs (Local Area Networks) or WANs (Wide Area Networks). This is the technology on which, for example, so-called Internet telephony, which is also frequently termed VoIP telephony (VoIP: Voice/Video over Internet Protocol), is based.

### BACKGROUND OF INVENTION

At the present point in time, setup of real time communication connections via a packet oriented communication network is frequently based on ITU-T Recommendation H.323. The H.323 Recommendation describes real time connections within a packet oriented communication network, as well as real time connections which are passed from a packet oriented communication network via a gateway device to a circuit switched communication network, e.g. an ISDN network, and from there to an external destination. If any given external connection destination is within a packet oriented communication network, the real time connection in question is switched via the circuit switched communication network to the gateway device of the external communication network and from there once again on a packet oriented basis to the external connection destination.

However, because of the dual transition from packet switching to circuit switching and back to packet switching, in some cases considerable impairments in terms of transmission performance and voice quality occur during this process. In addition, at the transition between packet and circuit switching, costly protocol conversion to Layer 3 of the OSI Reference Model must be carried out.

### SUMMARY OF INVENTION

The object of the present invention is to specify a network gateway device and a communication system enabling the abovementioned disadvantages associated with real time communication connections between different packet oriented communication networks to be avoided.

This object is achieved by a network gateway device having the features set forth in Claim 1 and a communication system having the features set forth in Claim 12.

The invention allows real time communication connections, e.g. for voice, video and/or multimedia communication, based on a packet oriented transport protocol such as the Internet Protocol or other protocols from the TCP/IP protocol family, to be set up between communication networks having different connection control protocols. Communication networks of this kind having a connection control protocol based on a packet oriented transport protocol, e.g. in accordance with ITU-T Recommendation H.323 or the SIP (Session Initiation Protocol) standard of the IETF Forum, are frequently also known as VoIP systems. VoIP systems may differ in respect of their connection control protocols and/or in respect of media data encoding methods used and/or may be administered by different operators in different administrative domains.

Different communication networks can be logically linked directly to the network gateway device according to the invention at transport protocol level. This means that for real time communication connections between the linked communication networks no media discontinuity occurs at least logically in respect of data transport and in particular there is no transition between packet and circuit switching. This is very advantageous in so far as many well -known packet oriented methods of ensuring quality of service can be used particularly effectively for logically continuous data packet transport. Moreover, no additional and very expensive conversion is necessary at transport protocol level, as is the case with conventional gateway devices which convert between packet and circuit switching.

According to the invention, the network gateway device has a conversion device for converting between the different connection control protocols of the linked communication networks. Within the framework of the connection control protocols, the conversion device can in particular convert between different connection signaling, different connection setup signaling and/or different quality of service signaling mechanisms. As the connection control protocols to be converted are based in each case on a packet oriented transport protocol, considerably lower conversion losses generally occur than with conventional gateway devices converting between packet and circuit switching.

In addition, because of the conversion of the connection control protocols, expensive-to-implement communication between connection/call control devices of the linked communication networks can generally be avoided.

Advantageous embodiments and developments of the invention are detailed in the dependent claims.

According to an advantageous development of the invention, there can be provided in the network gateway device a physical and/or logical separation between a signaling gateway for converting between the different connection control protocols and a media gateway for converting media data to be transmitted in the course of real time communication connections. The media gateway can convert between different media data encoding methods, e.g. as defined in ITU-T Recommendations G.711, G.723.1, G.729 or in accordance with the GSM Standard (Global System for Mobile Communication). The logical and/or physical separation results in a flexible, modular and therefore highly scalable network gateway device architecture. Thus for example a plurality of application-specific media gateways can also be assigned to and/or controlled by a signaling gateway.

The signaling gateway and the media gateway can preferably be linked by means of the H.248 protocol as per ITU-T Recommendation or by means of the so-called “Media Gateway Control Protocol” (MGCP) in accordance with the IETF Standard.

According to another advantageous development of the invention, the network gateway device can have, preferably in the signaling gateway, a proxy device for servicing control and/or request messages from one of the communication networks as stand-in for a device of another of the communication networks participating in a real time communication connection. Because of the proxy functionality of the network gateway device, no special treatment of inter-network real time communication connections is generally necessary on the part of a connection/call control device of a linked communication network.

In the network gateway device there can be provided in particular a proxy device for representing a feature supported in a first communication network and not supported in a second communication network compared to the first communication network.

In addition, the network gateway device can have, preferably in the signaling gateway, a feature gateway device for converting between different feature protocols of the different communication networks.

To increase operating security, the network gateway device can additionally have a firewall device connected between the data interfaces and performing data traffic monitoring particularly at connection control protocol level.

According to a further advantageous development of the invention, the network gateway device can have, preferably in the signaling gateway, an address resolution device enabling address information such as directory numbers, alias addresses, e-mail addresses, Internet addresses and/or other so-called URIs (Uniform Resource Identifiers) to be exchanged between the linked communication networks. Such an exchange of address information allows data packets in one of the communication networks to be provided with address information for another of the communication networks.

In addition the network gateway device can have, preferably in the signaling gateway, a quality of service control mechanism for converting quality of service classes of the connection control protocols to transport-protocol-specific quality of service classes. For this purpose there can be provided a quality of service control interface between the signaling gateway and the media gateway. Such an interface can preferably be implemented by means of an H.248 protocol or MGCP protocol extended to include a quality of service information signaling element.

### BRIEF DESCRIPTION OF THE DRAWING

An embodiment of the invention will now be explained in greater detail with reference to the accompanying drawing.

The FIGURE schematically illustrates a communication system with two packet oriented communication networks linked via a network gateway device.

### DETAILED DESCRIPTION OF INVENTION

The FIGURE schematically illustrates a communication system with two packet oriented communication networks KN1 and KN2 linked via a network gateway device NU. The communication networks KN1 and KN2 are implemented as so-called VoIP (Voice/Video over Internet Protocol) systems for real time communication connections for voice, video and/or multimedia communication. The Internet Protocol IP is implemented in both communication networks KN1 and KN2 as the transport protocol for transmitting data packets.

Whereas both communication networks KN1 and KN2 have the same transport protocol IP, they differ in respect of their connection control protocol. For the present embodiment it shall be assumed that in the communication network KN1 a signaling protocol SP 1 as specified in ITU-T Recommendation H.323 and in the communication network KN2 a signaling protocol SP1 different from signaling protocol SP2 are implemented as connection control protocols. The signaling protocol SP2 can, for example, be an SIP protocol (Session Initiation Protocol) per IETF Forum or an H.323 protocol which differs from the signaling protocol SP1 in terms of a different H.323 version, a different H.323 implementation and/or different H.323 connection setup options. The signaling protocols SP1 and SP2 are in each case based on the transport protocol IP. In the context of connection/call control, the signaling protocols SP1 and SP2 are used in particular for connection signaling, connection setup signaling, feature signaling (e.g. call diversion, call transfer) and/or quality of service signaling.

Typically the communication network KN1 can be a private corporate network (enterprise network) and the communication network KN2 can be a network operator's network (carrier network) or another external corporate network.

For real time transport of media data to be transmitted in the course o f real time communication connections, a real time protocol (RTP) is implemented in both communication networks KN1 and KN2. The real time protocol RTP is based on the so-called UDP protocol (User Datagram Protocol) which is in turn based on the Internet Protocol IP. According to a simpler variant, the media data payload can also be transmitted directly via the Internet Protocol IP instead of via the real time protocol RTP.

The communication network KN1 has a communications terminating device EE, such as a terminal, a personal computer, a communications application or a communications client, as well as a connection/call control device, such as a so-called gatekeeper GK as defined in Recommendation H.323. Setup of a real time communication connection to or from the communications terminating device EE is initiated by means of signaling—indicated by a double-headed arrow in the FIGURE—between the communications terminating device EE and the gatekeeper GK. In addition to connection/call control, the gatekeeper GK is also used for address resolution within the communication network, i.e. for converting between terminating device addresses, such as e.g. telephone numbers or aliases, and Internet Protocol addresses of parties. At startup of the network gateway device NU, it registers with the gatekeeper GK, preferably by RAS signaling (RAS: Registration Access Status) in accordance with ITU-T Recommendation H.225.0.

The network gateway device NU has a transport-protocol-based, in this case Internet-Protocol-based, data interface D1 via which the communication network KN1 is connected, and a transport-protocol-based, in this case Internet-Protocol-based, data interface D2 via which the communication network KN2 is connected. As the communication networks KN1 and KN2 are logically linked directly to the network gateway device by means of the same transport protocol IP, no media discontinuity detrimental to connection quality occurs at least logically. In particular no conversion on the transport layer or network layer is necessary, which greatly simplifies the architecture of the network gateway device NU.

The network gateway device NU additionally has a firewall device FW connected to the data interface D2 for monitoring the data traffic coming from the communication network KN2. The purpose of the firewall device FW is to allow only appropriately authorized data packets, e.g. only data packets of specific applications, to access the communication network KN1. In the present embodiment the firewall device FW is implemented in such a way that data packets to be exchanged in the course of real time communication connections between the communication networks KN1 and KN2 can pass through the firewall FW. Firewall devices implemented in this way are also frequently termed VoIP capable—or more specifically SIP or H.323 capable. The firewall device FW can preferably be implemented as a specific function of the network gateway device NU. Alternatively a VoIP-capable firewall device can also be implemented by means of a so-called firewall control protocol. In such a case the actual firewall device is controlled by a so-called firewall control function in the network gateway device NU or in the gatekeeper GK. The firewall device FW can preferably provide so-called NAT functionality (Network Address Translation) which allows conversion between internal Internet Protocol addresses valid only in the communication network KN1 and Internet Protocol addresses valid outside the communication network KN1.

The functional components of the network gateway device NU are a signaling gateway SG and a media gateway MG which is logically or physically separated from the signaling gateway. The media gateway MG is controlled by the signaling gateway SG by means of a so -called media gateway control protocol in accordance with ITU-T Recommendation H.428, possibly extended to include quality of service signaling elements. This coupling between signaling gateway SG and media gateway MG is indicated in the FIGURE by a double-headed arrow.

The media gateway MG is linked via the data interface D1 to the communication network KN1 and logically via the firewall device FW and the data interface D2 to the communication network KN2. The media gateway MG contains a media conversion device NIWU for converting between different media encoding schemes. Such a conversion is necessary for real time communication connections between a terminating device, here EE, of the communication network KN1 and the communication network KN2 if the communication networks KN1 and KN2 have no common media encoding, e.g. according to ITU-T Standard G.711, G.723.1, etc. In such a case, media data to be transmitted in the course of real time communication connections must be transmitted from the terminating device EE by means of the real time protocol RTP to the media conversion device NIWU where the media data is converted to a media encoding scheme used in the communication network KN2 and forwarded by means of the real time protocol RTP to the communication network KN2. A corresponding conversion is required for media data to be transmitted in the opposite direction.

If on the other hand a common media encoding scheme is provided in both communication networks KN1 and KN2, the media data packets can be transmitted directly by real time protocol RTP or Internet Protocol IP between the terminating devices involved in the real time communication connection, bypassing the media conversion device NIWU.

The signaling gateway SG is linked to the communication network KN1 via a signaling interface S1 based on the signaling protocol SP1 and sitting on top of the data interface D1, and to the communication network KN2 via a signaling interface S2 based on the signaling protocol SP2 and sitting on top of the data interface D2 via the firewall device FW. The signaling gateway SG has a conversion device SIWU as—preferably interchangeable—functional modules for converting between the signaling protocols SP1 and SP2, a proxy device PROXY, and an address resolution device BE for address resolution across communication networks.

The conversion device SIWU is used in the present embodiment for logically direct conversion between connection signaling according to the signaling protocol SP1, in this case an H.323 protocol, and connection signaling according to the signaling protocol SP2, in this case an H.323 or SIP protocol, at the level of the application layer of the OSI Reference model, in particular connection setup signaling, feature signaling and quality of service signaling being converted.

In the present example, the connection signaling according to the signaling protocol SP1 is transmitted from the gatekeeper GK via the data interface D1 and the signaling interface S1 to the conversion device SIWU where it is converted into connection signaling according to the signaling protocol SP2. This converted connection signaling is transmitted via the signaling interface S2, the firewall device FW and the data interface D2 to the communication network KN1. Transmission and conversion of connection signaling from the communication network KN2 to the gatekeeper GK is performed analogously in the reverse direction.

The proxy device PROXY is basically used for servicing control and/or request messages of the gatekeeper GK as stand-in for a party of the terminating device EE. In particular, feature signaling of the gatekeeper GK, e.g. in accordance with ITU-T Recommendation H.450, is logically terminated by the proxy device PROXY if a corresponding feature is not supported in the communication network KN2. In so far as features are signaled differently in the communication network KN2 as part of the signaling protocol SP2 compared to the communication network KN1, the conversion device SIWU performs a conversion between the different feature signaling mechanisms of the communication networks KN1 and KN2. By means of conversion of the signaling protocols SP1 and SP2 and in particular of any different feature signaling mechanisms by the signaling gateway SG, communication between the gatekeeper GK of the communication network KN1 and a corresponding gatekeeper (not shown) of the communication network KN2, which could otherwise only be implemented at great cost/complexity, can be avoided.

The address resolution device BE is used for inter-network exchange of address information between the communication networks KN1 and KN2 and is preferably implemented as a so-called border element in accordance with ITU-T Recommendation H.225.0 Annex G. For setup of a real time communication connection from the terminating device EE to the communication network KN2, a destination IP (Internet Protocol) address is inferred by the gatekeeper GK from a destination directory number entered at the terminating device EE. For this purpose it is necessary for the gatekeeper GK to exchange address information with the communication network KN2 via the address resolution device BE. Thus, for example, for each connection setup a relevant destination IP address can be requested from the communication network KN2. Alternatively, such an exchange also can take place on a call-independent basis.

For the purpose of exchanging address information, the gatekeeper GK communicates by means of an Internet Protocol based address resolution protocol ARP1 via the data interface D1 and the signaling interface S1 with the address resolution device BE which in turn communicates by means of an Internet Protocol based address resolution protocol ARP2 with the communication network KN2. The address resolution protocol ARP1 can preferably be implemented according to ITU-T Recommendation H.225.0 Annex G. Provided the communication network KN2 supports an H.323 protocol, the address resolution protocol ARP2 can likewise be implemented according to ITU-T Recommendation H.225.0 Annex G. If, on the other hand, the communication network KN2 supports the SIP protocol, a DNS-type protocol (DNS: Domain Name System) or the so-called TRIP protocol can be used as the address resolution protocol ARP2.

The network gateway device NU can be physically linked to the communication network KN2 in different ways, e.g. by means of Ethernet, xDSL (x Digital Subscriber Line), frame relay, ISDN, ATM, etc. The corresponding physical means of access can be provided either by the network gateway device NU or by external network devices such as so-called access routers.

However, disregarding the physical connection, there exists logically an Internet-Protocol-based linking of the communication network KN2 to the network gateway device NU. The use of the network gateway device NU according to the invention for logically linking different VoIP systems directly at the level of the transport protocol IP avoids any media discontinuity detrimental to connection quality.

Moreover, the network gateway device NU—particularly when three or more communication networks are linked—can be used as a multipoint conferencing unit. For this purpose the gateway unit can be enlarged to include a mixing function for mixing and distributing media data streams.

1-13. (canceled)

14. A network gateway device for real time communication connections, comprising:
a packet oriented transport protocol;
a first communication network with a first connection control protocol based on the transport protocol;
a second communication network with a second connection control protocol based on the transport protocol;
a communication connection between the first communication network and the second communication network;
a first and a second transport-protocol-based data interface for logically directly linking the first and the second communication network at transport protocol level;
a first signaling interface based on the first connection control protocol and connected to the first data interface, and a second signaling interface based on the second connection control protocol and connected to the second data interface; and
a conversion device linked to the first and second signaling interface and used for converting between the first and the second connection control protocol.

15. The network gateway device according to claim 14, wherein the transport protocol is implemented by an Internet protocol.

16. The network gateway device according to claim 14, wherein the first and/or the second connection control protocol is implemented by a protocol according to ITU-T Recommendation H.323.

17. The network gateway device according to claim 14, wherein the first and/or the second connection control protocol is implemented by means of the SIP protocol of the IETF Forum.

18. The network gateway device according to claim 14, wherein there exists a logical and/or physical separation into a signaling gateway for converting between the first and the second connection control protocol and a media gateway for converting media data to be transmitted in the course of real time communication connections.

19. The network gateway device according to claim 17, wherein the signaling gateway and the media gateway are linked by means of the H.248 protocol as per ITU-T recommendation.

20. The network gateway device according to claim 17, wherein the signaling gateway and the media gateway are linked by the so-called “Media Gateway Control Protocol” according to the IETF Standard.

21. The network gateway device according to claim 14, wherein a proxy device for servicing control and/or requesting messages from the first communication network as stand-in for a device of the second communication network participates in a real time communication connection.

22. The network gateway device according to claim 14, wherein a proxy device for representing a feature supported in the first communication network and not supported in the second communication network is compared to the first communication network.

23. The network gateway device according to claim 14, wherein a feature gateway device converts between different feature protocols of the first and second communication network.

24. The network gateway device according to claim 14, wherein a firewall device is connected between the data interfaces and used for data traffic monitoring particularly at the level of the connection control protocols.

25. The network gateway device according to claim 14, wherein an address resolution device for exchanging address information is located between the first and the second communication network.

26. The network gateway device according to claim 14, wherein a quality of service control mechanism for converting quality of service classes of the connection control protocols to quality of service classes at the transport protocol level.

27. A communication system, comprising:
a plurality of communication networks linked with a network gateway device;
a packet oriented transport protocol; and
a network gateway device having different connection control protocols based on the packet oriented transport protocol.

28. The communication system according to claim 24, wherein the plurality of communications networks comprises two private enterprise networks.

29. The communication system according to claim 24, wherein the plurality of communications networks comprises two carrier networks.

30. The communication system according to claim 24, wherein the plurality of communications networks comprises a private enterprise network and a carrier network.
